(19) United States
(12) Patent Application Publication
(10) Pub. No.: US 2010/0143769 A1
(43) Pub. Date: Jun. 10, 2010

(54) Anodic Dendritic Growth Suppression System for Secondary Lithium Batteries

(75) Inventors: Se-Hee Lee, Lakewood, CO (US); Edwin C. Tracy, Golden, CO (US); John Roland Pitts, Lakewood, CO (US)

Correspondence Address: PAUL J WHITE, PATENT COUNSEL;NATIONAL RENEWABLE ENERGY LABORATORY (NREL), 1617 COLE BOULEVARD, MS 1734, GOLDEN, CO, 80401-3393, US

(73) Assignee: Midwest Research Institute, Kansas City, MO (US)

(21) Appl. No.: 11/816,897

(22) PCT Filed: Jun. 11, 2007
(86) PCT No.: PCT/US07/70834

§ 371 Date: Aug. 22, 2007

(51) Int. Cl. H01M 10/02; H01M 4/134; H01M 10/0562; B32B 38/00; H02J 7/00

(52) U.S. Cl. 429/50; 429/231.95; 429/320; 429/322; 156/150; 320/137

(57) ABSTRACT

Provided herein are methods for manufacturing lithium-metal anode [18] assemblies for thin-film, thick-film and hulk secondary batteries that use liquid or gel-type electrolytes [14], and lithium-metal anode [18] assemblies for thick-film and bulk secondary batteries that use solid electrolytes [18]. These methods involve electrolytic formation of a lithium metal anode [18] between a protecting lithium-stable, solid electrolyte [18] material and an eieethcaiiy-Gonductive substance [20]. Secondary lithium_ batteries made by these methods aw also provided.

### CONTRACTUAL ORIGIN OF THE INVENTION

The United States Government has rights in this invention pursuant to Contract No. DE-AC36-99GO10337 between the United States Department of Energy and the Renewable Energy Laboratory, a Division of the Midwest Research Institute.

### BACKGROUND ART

Lithium rechargeable (secondary) batteries have been widely used as power sources for portable electronic equipment in the fields of office automation equipment, household electronic equipment, communication equipment and the like.

A conventional lithium rechargeable battery has a negative electrode (the anode) comprising an active material which releases lithium ions when discharging, and intercalates or absorbs lithium ions when the battery is being charged. The negative active materials commonly utilized in lithium ion batteries include, carbon, 3d-metal oxides, nitrides and similar materials capable of intercalating lithium ions. The positive electrode (the cathode) of a conventional lithium ion battery contains a substance capable of reacting chemically or interstitially with lithium ions, such as transition metal oxides, including vanadium oxides, cobalt oxides, iron oxides, manganese oxide and the like. In general, the positive active material comprised by the positive electrode will react with lithium ions in the discharging step of the battery, and release lithium ions in the charging step of the battery.

The external faces of the anode and cathode lithium ion batteries are usually equipped with some structure or component to collect the charge generated by the battery during discharge and to permit connection to an external power source during recharging. Conventional lithium ion batteries usually comprise a non-aqueous liquid or a solid polymer electrolyte, which contains a dissolved lithium salt that is capable of dissociating to lithium ion(s) and anions, such as for example lithium perchlorate, lithium borohexafluoride, and other lithium salts that are soluble in the electrolyte utilized. During discharge, lithium ions from the anode pass through the liquid electrolyte to the electrochemically-active material of the cathode where the ions are taken up or absorbed with simultaneous release of electrical energy. During charging, the flow of ions is reversed so that lithium ions pass from the electrochemically-active cathode material through the electrolyte and are plated back onto the anode.

Electrochemical devices such as lithium secondary batteries can use a solid, liquid, or polymer gel-type electrolyte as the ion-conducting material, and therefore are referred to as either solid-state, liquid or polymer gel (also known as gel-type) devices, respectively. The electrolyte material must possess high ionic conductivity (i.e., must conduct positive ions such as Li⁺ or H⁺) and low electronic conductivity (must not conduct electrons).

During the manufacture of solid-state thin-film electrochemical devices, the solid electrolyte layer (which is disposed between the cathode and the anode) is deposited in a manner which often results unavoidably in the formation of “pinholes.” Pinholes are defects in the solid electrolyte layer which act as electron “channels” between the cathode and the anode. Liquid or gel-type electrochemical devices were developed to alleviate the “shorting” problems associated with solid state electrochemical devices. Liquid or gel-type electrochemical devices have a liquid or gel material as the ion-conducting layer, which is typically formed by sandwiching the liquid or gel-type ion-conducting material between the cathode and the anode after the electrochemical device has been assembled. Consequently, liquid or gel-type thin-film electrochemical devices do not suffer the drawback of pinholes as in solid-state devices.

The foregoing examples of related art with limitations related thereto are intended to be illustrative and not exclusive. Other limitations and teachings of the related art will become apparent to those of skill in the art upon a reading of the specification and a study of the drawings.

### DISCLOSURE OF THE INVENTION

It has been discovered that assemblies for secondary batteries having liquid or gel-type electrolytes and lithium metal anodes can be manufactured by a process involving depositing a layer of an electronically-insulating, lithium ion-conducting, lithium-stable, solid electrolyte on a substrate, and plating lithium ions through the solid electrolyte onto the substrate to form a lithium metal anode in an electrolyte bath. Since it is impossible to directly deposit the solid electrolyte onto lithium metal, this process allows such anode assemblies to be efficiently manufactured. They can then be combined with cathode assemblies and other elements required for completion of the batteries, such as terminals and casings.

These batteries provide safety advantages because the protective solid electrolyte layer between the lithium metal anode and the liquid or gel-type electrolyte prevents formation of dendrites during recharging of the battery. Dendrites cause shorting and explosions that have injured users of batteries that have lithium metal anodes. In addition, the solid electrolyte, made of a material that is stable in contact with lithium metal, prevents degradation of the anode.

In addition to the exemplary aspects and embodiments described above, further aspects and embodiments will become apparent by reference to the drawings and by study of the following descriptions.

### BRIEF DESCRIPTION OF DRAWINGS

FIG. 1 shows a cross-section of a secondary battery having a liquid or gel-type electrolyte and a lithium metal anode covered with a layer of an electronically-insulating, lithium ion-conducting, lithium-stable, solid electrolyte that prevents contact of the lithium metal anode with the liquid or gel-type electrolyte.

FIG. 2 shows a cross-section of a prior-art configuration of a secondary battery having a liquid or gel-type electrolyte and a lithium metal anode, but lacking the solid electrolyte layer adjacent to the anode. This figure illustrates the growth of lithium metal dendrites that occurs during recharging of such batteries.

FIG. 3 is a cross-sectional view illustrating a process conducted in an electrolyte solution for forming a lithium metal anode between a substrate and a solid electrolyte protective layer.

Exemplary embodiments are illustrated in referenced figures of the drawings. It is intended that the embodiments and figures disclosed herein are to be considered illustrative rather than limiting.

### BEST MODE FOR CARRYING OUT THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Lithium batteries are of two types. Lithium-ion batteries used as anodes lithium compounds such as lithium carbide. Lithium-metal batteries use elemental lithium metal as anodes. Lithium metal anodes are more efficient, but because of lithium metal's reactivity, have not been successfully commercialized due to safety hazards. One cause of injuries to battery users is the growth of dendrites on the lithium anode extending through the electrolyte and causing shorting and explosions.

Lithium batteries can be made in various sizes. They can be thin-film batteries having cathode and anode layers of less than about 5 μm in thickness and capable of delivering about 20 μAh/cm² to about 0.3 mAh/cm² of current. These thin-film batteries are typically used in devices such as Complementary Metal Oxide Semiconductor (CMOS) back-up power, micro-sensors, smart cards, radio frequency identification (RFID) devices, and micro-actuators. Lithium batteries can also be thick-film batteries having cathode and anode layers of between about 5 μm and about 20 μm in thickness and capable of delivering about 0.3 mAh/cm² to about 1.2 mAh/cm² of current. These thick-film batteries are typically used in devices such as RFID, personal digital assistants (PDAs), and other portable electronic devices. In addition, lithium batteries can be bulk batteries having cathodes and anodes greater than about 20 μm in thickness up to about 100 μm in thickness, and capable of delivery about 1.2 mAh/cm² to about 6 mAh/cm² of current. These bulk batteries are typically used in devices such as laptop computers, hybrid electric vehicles and plug-in hybrid electric vehicles. Lithium-metal anode assemblies as described herein can be manufactured for all these battery sizes by the methods disclosed herein.

This disclosure provides methods that allow the manufacture of lithium-metal anode assemblies for thin-film, thick-film and bulk secondary batteries that use liquid or gel-type electrolytes, as well as providing lithium-metal anode assemblies for thick-film and bulk secondary batteries that use solid electrolytes. Since lithium metal anodes have ten times the capacity of lithium carbide anodes, and lithium is one-tenth the weight and one-third the volume of lithium carbide anodes having equivalent electrical capacity, the anode assemblies and batteries incorporating them have higher electrical capacities for the same size and weight, or have reduced size and weight for the same electrical capacities.

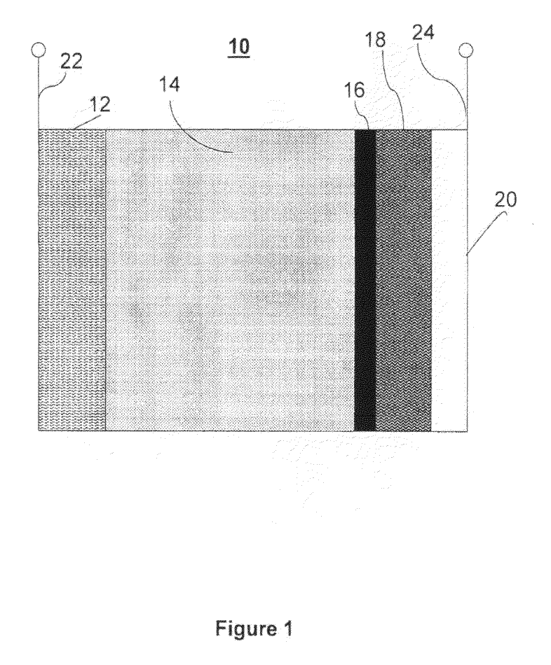

FIG. 1 shows a cross-section of a secondary battery 10 having a cathode 12 in contact with a liquid or gel-type electrolyte 14, which is in turn in contact with a layer of an electronically-insulating, lithium ion-conducting, lithium-stable, solid electrolyte 16 that prevents contact of adjacent lithium metal anode 18 with the liquid or gel-type electrolyte 14. The lithium metal anode 18 is formed between a substrate 20 and the solid electrolyte 16. Also shown are cathode (positive) terminal 22 in electrical contact with cathode 12, and anode (negative) terminal 24 in electrical contact with substrate 20. When the battery is a thick-film or bulk battery, the electrolyte 14 may also be a solid-state electrolyte.

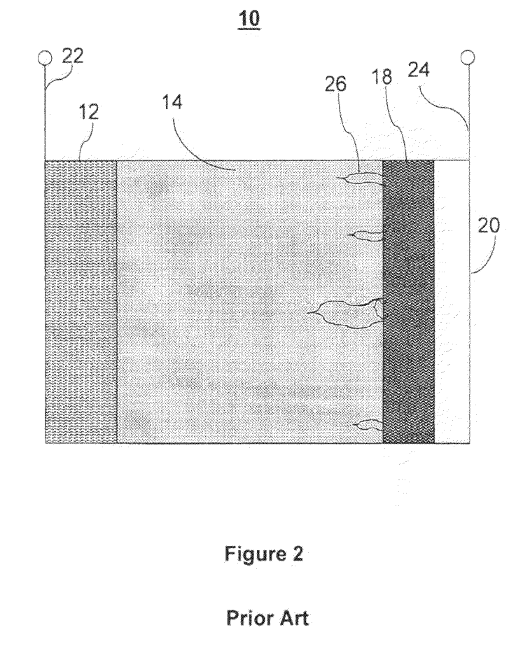

FIG. 2 shows a cross-section of a prior-art configuration of a secondary battery 10 having a cathode 12 in contact with a liquid or gel-type electrolyte 14 in contact with a lithium metal anode 18 adjacent to a substrate 20. This figure shows undesirable growth of lithium metal dendrites 26 that occurs during recharging of the battery. Also shown are cathode (positive) terminal 22 in electrical contact with cathode 12, and anode (negative) terminal 24 in electrical contact with substrate 20.

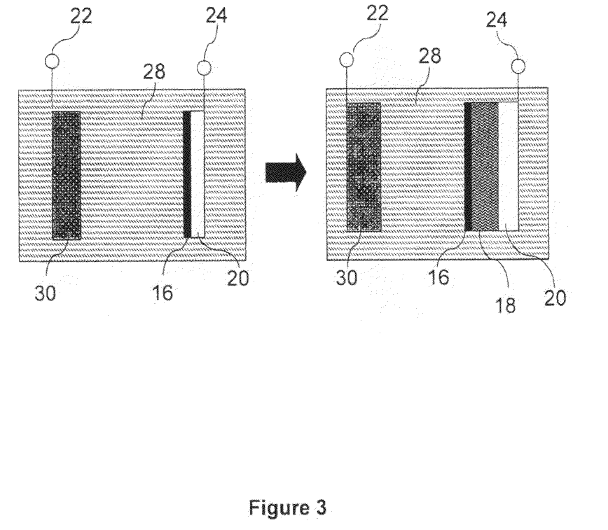

FIG. 3 is a cross-sectional view illustrating a process conducted in an electrolyte bath 28 for forming a lithium metal anode 18 between a substrate 20 and a solid electrolyte protective layer 16. A lithium-containing cathode 30 equipped with a cathode terminal 22 is placed in electrolyte bath 28. Also placed in electrolyte bath 28 is a substrate 20 equipped with an anode terminal 24. Substrate 20 has been covered with a layer of an electronically-insulating, lithium ion-conducting, lithium-stable, solid electrolyte 16 that is substantially stable in contact with lithium metal. Current is flowed between the anode and cathode terminals, causing lithium ions from cathode 30 to plate onto substrate 20 through solid electrolyte 16 to form a lithium metal anode 18.

Liquid or gel-type electrolytes useful in this application include any electrolytes of this type known to the art. Conventional lithium batteries typically use non-aqueous liquids or polymer electrolytes that contain a dissolved lithium salt that is capable of dissociating to lithium ion(s) and anions. These lithium salts include, for example, lithium perchlorate, lithium borohexafluoride, and other lithium salts that are soluble in the electrolyte utilized. During discharge, lithium ions from the anode pass through the liquid electrolyte to the electrochemically-active material of the cathode, where the ions are taken up or absorbed with the simultaneous release of electrical energy. During charging, the flow of ions is reversed so that lithium ions pass from the electrochemically-active cathode material through the electrolyte and are plated back to form the anode. Electrolyte materials that have high ionic conductivity and low electric conductivity are useful in embodiments hereof. The liquid or gel-type electrolyte is desirably an excellent conductor of lithium ions (Li⁺).

The liquid electrolyte can be obtained by dissolving a lithium salt in a suitable solvent—preferably a non-aqueous solvent. Suitable lithium salts for preparing a liquid electrolyte include LiClO₄, LiBF₄, LiAlCl₄, LiCF₃SO₃, LiAsF₆, LiCl, and other lithium compounds known in the art which exhibit similar ion-conducting properties. Suitable non-aqueous solvents for use in preparing liquid electrolyte material include propylene carbonate, tetrahydrofuran and its derivatives, acetonitrile, 1,3-dioxalane-methyl-2-pyrrolidone, sulpholane methylformate, dimethyl sulfate, butyrolactone, 1,2-dimethoxyethane, and other non-aqueous solvents that are known in the art to exhibit similar properties. In one embodiment, the electrolyte is a material comprising LiClO₄ dissolved in propylene carbonate to form a 1 molar concentration.

When the electrolyte is a gel-type electrolyte material (also known in the art as a polymer get electrolyte), the gel-type electrolyte material can be obtained by adding a conventional liquid electrolyte (e.g., lithium perchlorate dissolved in propylene carbonate) to a cross-linkable polymer host that functions as a container for the liquid electrolyte material. Suitable polymer hosts include, but are not limited to, polyacrylonitrile, poly(ethylene oxide), poly(methyl methacrylate), poly(vinylidene fluoride), poly(vinylidene fluoride-co-hexafluoropropylene), polyethylene glycol, diacrylate, and trimethylolpropene triacrylate.

Also disclosed herein are processes useful for making secondary thin-film, thick-film, and bulk batteries, or portions thereof, having lithium metal anodes. The “portions” of such batteries made by the processes disclosed herein are lithium metal anode assemblies useful as components in such batteries. An anode assembly described and enabled by the disclosure hereof comprises an electronically-conductive substrate; a lithium metal anode in contact with said substrate; and an electronically-insulating, lithium ion-conducting, lithium-stable, solid electrolyte covering said lithium metal anode.

A lithium-metal anode is a structure in which the active element is elemental lithium, rather than a lithium alloy or other lithium-containing compound. The anode may be in the form of a thick or thin layer that has been deposited on the substrate by means known to the art such as for example, vacuum evaporation, pyrolytic decomposition, sputtering, chemical vapor deposition, including plasma-enhanced chemical vapor deposition, and the like. Or it may be a foil or thicker lithium metal structure such as a lithium metal bar or column.

The electrically-conductive substrate can be any anode current collector material known to the art, e.g., a material selected from the group consisting of stainless steel, iron, gold, copper, transition metals that do not form intermetallic compounds with lithium, and glass or a plastic onto which an electrically-conductive film has been deposited. Examples of transition metals that do not form intermetallic compounds with lithium include Mo, Ni, Cu, W, Ta, and Co.

The electronically-insulating, lithium ion-conducting, lithium-stable, solid electrolyte used to cover the lithium metal anode is a material that is known to the art to conduct lithium ions but not electrons, and to be stable in contact with lithium metal. The term “stable” as used herein with respect to this material means that the material reacts minimally, if at all, with lithium metal, and does not degrade the lithium metal anode such that its usefulness is destroyed even after repeated cycles, e.g., up to about 1000 or more cycles. Typically, substoichiometric lithium phosphorous oxynitride is used as such a stable, solid electrolyte layer. Substiochiometric lithium phosphorous oxynitride is a family of materials having the general formula LiₓPO_{y}N_{z}. In the “as deposited” state, the material has values for x and y of about 3, and for z of about 1.5. These materials are referred to herein as Lipon.

Solid lithium-stable electrolyte materials useful herein also include glass-forming compound that are stable against metallic lithium, such as lithium silicates, lithium borates, lithium aluminates, lithium phosphates, lithium phosphorus oxynitrides, lithium silicosulfides, lithium borosulfides, lithium aluminosulfides, and lithium phosphosulfides. Specific examples of protective solid-state electrolyte materials include 6Lil-Li₃PO₄—P₂S₅, B₂O₃—LiCO₃-Li₃PO₄, Lil-Li₂O—SiO₄, Lil, Li₂WO₄, LiSO₄, LilO₃, Li₄SiO₄, Li₂Si₂O₅, LiAlSiO₄, Li₄(Si_{0.7}Ge_{0.3})O₄, Li₄GeO₄, LiAlCl₄, Li₃PO₄, Li₃N, Li₂S, Li₂O, Li₅AlO₄, Li₅GaO₄, Li₆ZnO₄, LiAr₂(PO₄)₃, LiHF₂(PO₄)₃, LilNS₂, LiMgF, LiAlMgF₄, Li₂S—P₂S₅, Lil-Li₂S—P₂S₅, and Li₂S—GeS₂—P₂S₅.

The solid, lithium-stable electrolyte material covers the lithium metal anode. The term “covers” as used in this context means that the solid electrolyte material is in contact with the lithium metal anode and surrounds any portion of the anode that, in use, would otherwise be in contact with another solid electrolyte or a liquid or gel-type electrolyte in an electrochemical cell so as to protect the lithium metal anode from the electrolyte.

Additional components such as cathodes, electrolytes, terminals, casings and other components known in the art can he combined with the anode assemblies described herein to produce operating batteries for powering electrical devices. Secondary batteries having liquid, gel-type or solid electrolytes (which solid electrolytes may be composed entirely of the electronically-insulating, lithium ion-conducting, lithium-stable, solid electrolyte discussed above, or may additionally comprise a second solid electrolyte material) can be produced by methods disclosed herein. In one embodiment, the batteries are thick-film or bulk batteries. In further embodiments, the batteries are thin-film batteries having liquid or gel-type electrolytes.

The second solid electrolyte, in contact with the first lithium-stable solid electrolyte that covers the anode, is particularly useful in thick-film or bulk-type secondary lithium batteries. This second electrolyte may be any solid electrolyte or combination of solid electrolytes, e.g., as known to the art. Second solid electrolyte materials include, but are not limited to, lithium ion conductors including polymers known to the art such as polyethers, polyimines, polythioethers, polyphosphazenes, and polymer blends, mixtures, and copolymers thereof in which an appropriate electrolyte salt has optionally been added. In some embodiments the polymeric electrolytes are polyethers or polyalkyiene oxides. Typically, for a solid electrolyte, the polymeric electrolyte contains less than about 20% liquid. The second electrolyte material can also be a ceramic or glass such as beta alumina-type materials. Specific examples include sodium beta alumina, Nasicon™ or Lisicon™ glass or ceramic. Other suitable solid electrolytes include Li₃N, LiF₃, LiAlF₄ and Li₁₋ₓAlₓTi₂₋ₓ(PO4)₃ wherein the value of x is determined by the amount of Al in the compound, as is known to the art.

Also provided herein is a method of making an anode assembly for a lithium-metal secondary battery, said method comprising: providing an electronically-conductive substrate; at least partially covering said substrate with an electronically-insulating, lithium ion-conducting, lithium-stable, solid electrolyte material; providing a lithium-containing cathode material; providing an electrolyte bath sized to receive said cathode material and said substrate that is at least partially covered with said solid electrolyte material; immersing said cathode and said substrate that is at least partially covered with said solid electrolyte material into said electrolyte bath; and flowing an electrical current between said substrate and said cathode whereby a lithium metal anode is deposited on said substrate through said solid electrolyte material.

The substrate is covered with the solid, lithium-stable electrolyte material at least partially, i.e., at least to the extent required se that lithium metal subsequently formed on the substrate will be protected from other electrolyte materials present in the battery that is assembled using the anode assembly.

The lithium-containing cathode material is any material known to the art to be a source of lithium ions, such as lithium vanadate, manganate, lithium nickelate, lithium cobaitate, lithium molybdenum oxide, and lithium titanium oxide. In some embodiments, the cathode material can be formed by lithiating a transition metal oxide material.

The electrolyte bath comprises a properly-sized container containing sufficient electrolyte solution to cover the cathode and solid-electrolyte-covered substrate. Suitable electrolyte baths are known to the art. Suitable electrolyte solutions are also known to the art and may be selected from the group consisting of solutions of commercially available LiClO₄—PC, LiPF₆-EC-DMO, LiBF₄-EMG, and any combinations thereof.

In some embodiments, e.g., thin-film batteries, the lithium metal anode is deposited to a thickness of between about 100 nm and about 2 μm, or between about 0.2 and about 2 μm. In other embodiments, e.g., thick-film batteries, the lithium metal anode is deposited to a thickness of between about 2 μm and about 10 μm. In further embodiments, e.g., bulk batteries, the lithium metal anode is deposited to a thickness of between about 10 μm and about 100 μm.

Secondary lithium batteries comprising an anode assembly made by the foregoing methods and also comprising liquid or gel-type electrolytes, wherein the lithium metal anode is prevented from contact with the liquid or gel-type electrolyte by the electronically-insulating, lithium ion-conducting, lithium-stable, solid electrolyte material, are described and enabled herein.

Thick-film and bulk secondary lithium batteries made by the methods disclosed above and comprising a solid electrolyte as the only electrolyte are provided herein. The solid electrolyte may be comprised entirely of the electronically-insulating, lithium ion-conducting, lithium-stable, solid electrolyte material that protects the lithium anode; or may include a second solid electrolyte material as described above, in contact With the electronically-insulating, lithium ion-conducting, lithium-stable, solid electrolyte material.

The secondary lithium batteries disclosed herein are useful for powering electrical devices, and electrical devices powered by these batteries are made possible by the disclosure hereof. The batteries may be used to provide electric currents to such devices by placing in operative electrical connection with such a device, a secondary lithium battery comprising: a lithium metal anode; a liquid or gel-type electrolyte; and a lithium-stable, electrically insulating, lithium-ion-conducting solid electrolyte material covering said lithium metal anode so as to prevent contact between said anode and said liquid or gel-type electrolyte. Thick-film or bulk lithium secondary batteries comprising a lithium metal anode; a lithium-stable, electrically insulating, lithium-ion-conducting solid first electrolyte covering said lithium metal anode; and a solid-state second electrolyte, wherein the first electrolyte prevents direct contact between said anode and the second electrolyte, may be similarly used to power electronic devices.

In a further embodiment hereof, a method of recharging a lithium battery is provided comprising flowing an electric current into an anode of a secondary lithium battery comprising a lithium metal anode; liquid or gel-type electrolyte; and a lithium-stable, electrically insulating, lithium-ion-conducting solid electrolyte material situated between the anode and the liquid or gel-type electrolyte so as to prevent contact therebetween; whereby dendrite formation on the lithium metal anode is prevented.

Li metal anodes encapsulated between electrically conductive substrates and solid lithium stable overlayers can be created by a two-step fabrication process: a) a solid lithium stable inorganic ion conductor is deposited onto substrate by evaporation; wherein this layer can also be deposited by sputtering, chemical vapor deposition (CVD), pulsed laser deposition (PLD), or other suitable method known to the art, and b) the lithium metal anode is subsequently formed by electrochemical plating through the solid ion-conductor. A variety of solid-state inorganic ion conductors (mentioned above) can be deposited by several different vacuum deposition methods such as reactive sputtering, co-evaporation (thermal or e-beam evaporation), or pulsed laser deposition. A variety of liquid electrolyte systems are used to obtain the good morphological and interfacial stability of the solid-state ion conductor and lithium metal.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. An anode assembly designed in use to be a component of a secondary lithium battery, said anode assembly comprising:
a. an electronically-conductive substrate;
b. a lithium metal anode in contact with said substrate; and
c. an electronically-insulating, lithium ion-conducting, lithium-stable, solid electrolyte covering said lithium metal anode.

2. The anode assembly of claim 1 designed to be a component of a thin-film secondary lithium battery wherein said lithium metal anode has a thickness of between about 0.2 and about 2 μm.

3. The anode assembly of claim 1 designed in use to be a component of a thick-film lithium secondary battery; wherein said lithium metal anode has a thickness of between about 2 and about 10 μm.

4. The anode assembly of claim 1 designed in use to be a component of a bulk lithium secondary battery; wherein said lithium metal anode has a thickness of between about 10 and about 100 μm.

5. The anode assembly of any of claims 1-4 wherein said substrate is comprised of a material selected from the group consisting of stainless steel, iron, gold, copper, transition metals that do not form intermetallic compounds with lithium, and glass or a plastic onto which an electrically-conductive film has been deposited.

6. The anode assembly of any of claims 1-5 wherein said electronically-insulating, lithium ion-conducting, lithium-stable, solid electrolyte is made of a material selected from the group consisting of lithium silicates, lithium borates, lithium aluminates, phosphates, lithium phosphorus oxynitrides, lithium silicosulfides, lithium borosulfides, lithium aluminosulfides, and lithium phosphosulfides.

7. The anode assembly of claim 6 wherein said electronically-insulating, lithium ion-conducting, lithium-stable, solid electrolyte is made of Lipon.

8. A thick-film or bulk secondary lithium battery comprising the anode assembly of any of claims 1-7.

9. A thin-film battery comprising the anode assembly of any of claims 1-7 and additionally comprising a liquid or gel-type electrolyte.

10. A method of making an anode assembly for a lithium-metal secondary battery, said method comprising:
a. providing an electronically-conductive substrate;
b. at least partially covering said substrate with an electronically-insulating, lithium ion-conducting, lithium-stable, solid electrolyte material;
c. providing a lithium-containing cathode material;
d. providing an electrolyte bath sized to receive said cathode material and said substrate that is at least partially covered with said solid electrolyte material;
e. placing said cathode and said substrate that is at least partially covered with said solid electrolyte material into said electrolyte bath; and
f. flowing an electrical current between said substrate and said cathode, whereby a lithium metal anode is deposited on said substrate through said solid electrolyte material.

11. The method of claim 10 wherein said substrate is comprised of a material selected the group consisting of stainless steel, iron, gold, copper, transition metals that do not form intermetallic compounds with lithium, and glass or a plastic onto which an electrically-conductive film has been deposited.

12. The method of claim 10 or 11 wherein said electronically-insulating, lithium ion-conducting, lithium-stable, solid electrolyte material is selected from the group consisting of lithium silicates, lithium borates, lithium aluminates, lithium phosphates, lithium phosphorusoxynitrides, lithium silicosulfides, lithium borosulfides, lithium aluminosulfides, and lithium phosphosulfides.

13. The method of any of claims 10-12 wherein said electronically-insulating, lithium ion-conducting, lithium-stable, solid electrolyte material is Lipon.

14. The method of any of claims 10-13 wherein said lithium-containing cathode material is selected from the group consisting of lithium vanadate, lithium manganate, lithium nickelate, and lithium cobaltate.

15. The method of any of claims 10-14 wherein said electrolyte bath is a container comprising an electrolyte solution selected from the group consisting of: LiClO₄—PC, LiPF₆-EC-DMC, and LiBF₄-EMC.

16. The method of any of claims 10-15 wherein said lithium metal anode is deposited to a thickness of between about 100 nm and about 2 μm.

17. The method of any of claims 10-15 wherein said lithium metal anode is deposited to a thickness of between about 2 μm and about 10 μm.

18. The method of any of claims 10-15 wherein said lithium metal anode is deposited to a thickness of between about 10 μm and about 100 μm.

19. A secondary lithium battery comprising the anode assembly made by the method of any of claims 10-18 comprising a liquid or gel-type electrolyte, wherein said lithium metal anode is prevented from contact with said liquid or gel-type electrolyte by said electronically-insulating, lithium ion-conducting, lithium-stable, solid electrolyte material.

20. A thick-film or bulk secondary lithium battery made by the method of any of claims 10-18 comprising a solid electrolyte as the only electrolyte, wherein said solid electrolyte is comprised entirely of said electronically-insulating, lithium ion-conducting, lithium-stable, solid electrolyte material; or is comprised of one or more second solid electrolyte material(s), in contact with said electronically-insulating, lithium ion-conducting, lithium-stable, solid electrolyte material.

21. An electrically-powered device comprising the secondary battery of claim 19 or 20.

22. A method of providing an electric current to a device comprising:
a. placing in operative electrical connection with said device, a secondary lithium battery comprising:
i. a lithium metal anode;
ii. a liquid or gel-type electrolyte; and
iii. a lithium-stable, electrically insulating, lithium-ion-conducting solid electrolyte material covering said lithium metal anode so as to prevent contact between said anode and said liquid or gel-type electrolyte; and
b. activating said battery to provide an electrical current to said device.

23. A method of providing an electric current to a device comprising:
a. placing in operative electrical connection with said device, a thick-film or bulk secondary lithium battery comprising:
i. a lithium metal anode;
ii. an electrically-insulating, lithium-ion-conducting, lithium-stable, solid first electrolyte covering said lithium metal anode; and
iii. a solid-state second electrolyte in contact with said lithium-stable solid first electrolyte;
wherein said first electrolyte prevents direct contact between said anode and said liquid second electrolyte; and
b. activating said battery to provide an electrical current to said device.

24. A method of recharging a lithium battery comprising flowing an electric current into an anode of a secondary lithium battery that comprises:
a. a lithium metal anode;
b. a liquid or gel-type electrolyte; and
c. a lithium-stable, electrically insulating, lithium-ion-conducting solid electrolyte layer situated between said anode and said liquid or gel-type electrolyte so as to prevent contact therebetween;
whereby dendrite formation on said lithium metal anode is prevented.
